(19) United States
(12) Patent Application Publication
(10) Pub. No.: US 2026/0112519 A1
(43) Pub. Date: Apr. 23, 2026

(54) CONDUCTIVE MEMBER AND CONDUCTIVE MEMBER ATTACHMENT STRUCTURE

(71) Applicant: HONDA MOTOR CO., LTD., Tokyo (JP)

(72) Inventor: Kyogo WATABE, Tokyo (JP)

(73) Assignee: HONDA MOTOR CO., LTD., Tokyo (JP)

(21) Appl. No.: 19/331,509

(22) Filed: Sep. 17, 2025

(30) Foreign Application Priority Data
Oct. 21, 2024 (JP) 2024-184645

(51) Int. Cl. H01B 5/02

(52) U.S. Cl. CPC H01B 5/02

(57) ABSTRACT

A conductive member includes: a flat conductive portion; and an insulating protective cover provided to cover an outer peripheral surface of the conductive portion, the conductive member is configured to connect two electrical components, the conductive portion includes a body covered with the protective cover, and a first connection portion and a second connection portion that are exposed from the protective cover and are to be electrically connected to a terminal of each of the electrical components, at least one connection portion among the first connection portion and the second connection portion is bent with respect to the body, and the protective cover is provided with an extension portion extending from a position of the protective cover corresponding to a bent portion between the at least one connection portion and the body.

### CROSS-REFERENCE TO RELATED APPLICATION

This application is based on and claims priority under 35 USC 119 from Japanese Patent Application No. 2024-184645 on October 21, 2024.

### TECHNICAL FIELD

The present invention relates to a conductive member for connecting two electrical components, and a conductive member attachment structure.

### BACKGROUND ART

In recent years, efforts to realize a low-carbon society or a decarbonized society become active, and research and development about an electrification technique are conducted to reduce CO₂ emission and improve energy efficiency in vehicles.

Patent Literature 1 discloses an electrical connection box mounted on a vehicle to store a fuse, which is an electrical component, in an electrical component storage accommodating portion. A structure is disclosed in which a step portion is formed at a bus bar connected to a terminal of the electrical connection box and a gap between the bus bar and a protective cover covering the terminal is narrowed to prevent a finger from entering the electrical component storage accommodating portion (finger touch prevention structure).

Patent Literature 1: JP2024-009566A

### SUMMARY OF INVENTION

In the electrical connection box and the bus bar as disclosed in Patent Literature 1, in order to secure a space beside the electrical connection box and improve mountability of the electrical connection box, it may be preferable to bend a conductor exposed portion (connection portion) that is a portion of the bus bar connected to the terminal of the electrical connection box. In such a case, since the finger touch prevention structure is not sufficiently ensured in the step portion formed at the bus bar in Patent Literature 1, it is required to consider a structure that ensures safety.

The present invention provides a conductive member and a conductive member attachment structure that can achieve both mountability and safety.

The present invention provides a conductive member including:

a flat conductive portion; and

an insulating protective cover provided to cover an outer peripheral surface of the conductive portion, in which

the conductive member is configured to connect two electrical components,

the conductive portion includes

a body covered with the protective cover, and

a first connection portion and a second connection portion exposed from the protective cover and being to electrically connected to a terminal of each electrical component,

at least one connection portion among the first connection portion and the second connection portion is bent with respect to the body, and

the protective cover is provided with an extension portion extending from a position corresponding to a bent portion between the at least one connection portion and the body.

The present invention also provides a conductive member attachment structure including:

the conductive member described above; and

a first electrical component and a second electrical component respectively connected to the first connection portion and the second connection portion of the conductive member, in which

the first electrical component and the second electrical component each include

a terminal block including a terminal to which the first connection portion or the second connection portion of the conductive member is connected, and

a terminal cover disposed at the terminal block and covering the terminal to which the first connection portion or the second connection portion is connected,

a slit that allows the first connection portion or the second connection portion to be inserted therethrough is provided between the terminal block and the terminal cover, and

the extension portion of the protective cover has a plate shape covering the slit when viewed from a first direction.

According to the present invention, since the connection portion of the conductive portion is bent with respect to the body, mountability of the electrical component to which the conductive member is connected is improved. In addition, in the conductive member including such a bent connection portion, since the protective cover is provided with the extension portion extending from the position corresponding to the bent portion between the connection portion and the body, it is possible to prevent a hand or a tool of an operator from coming into contact with the connection portion in a state where the electrical component and the conductive member are connected.

### BRIEF DESCRIPTION OF DRAWINGS

FIG. 1 is a perspective view of a conductive member 40.

FIG. 2 is a front view of the conductive member 40.

FIG. 3 is an exploded perspective view of a battery pack 10 mounted on a vehicle and including battery modules 11.

FIG. 4 is a side view of the battery pack 10 in a state where two battery modules 11 are connected by the conductive member 40.

FIG. 5 is a perspective view of the conductive member 40 in a state where two battery modules 11 are connected.

FIG. 6 is a top view of the conductive member 40 in a state where two battery modules 11 are connected.

FIG. 7A is a cross-sectional view taken along line A-A in FIG. 6, and FIG. 7B is a cross-sectional view taken along line B-B.

FIG. 8 is a perspective view of a conductive member 40A according to a modification.

### DESCRIPTION OF EMBODIMENTS

Hereinafter, an embodiment of a conductive member and a conductive member attachment structure of the present invention will be described with reference to the accompanying drawings. The drawings are viewed in directions of reference signs.

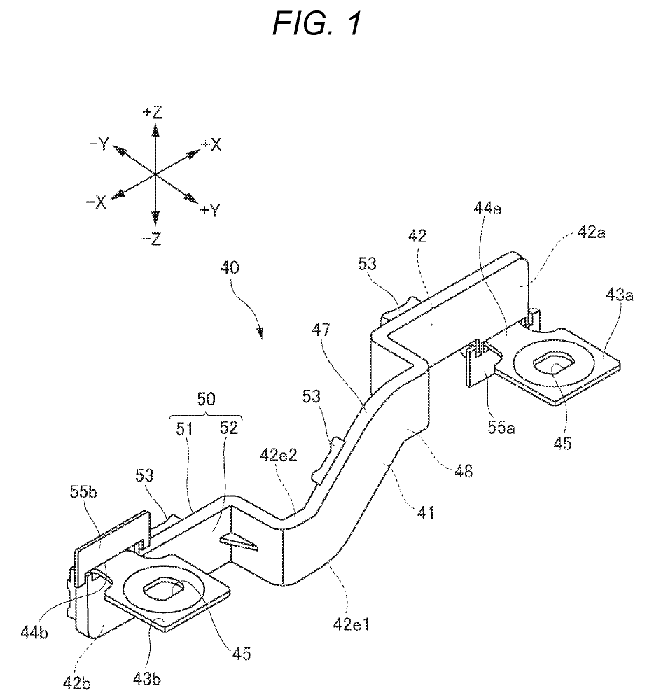

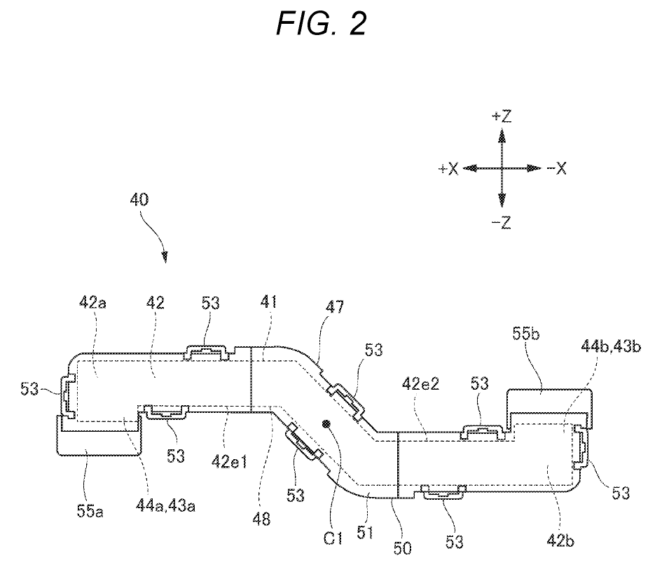

First, a conductive member 40 according to the embodiment of the present invention will be described with reference to FIGS. 1 and 2.

FIG. 1 is a perspective view of the conductive member 40. FIG. 2 is a front view of the conductive member 40. In descriptions of FIGS. 1 and 2, directions of arrows illustrated in the drawings are referred to as an X-axis direction, a Y-axis direction, and a Z-axis direction, respectively.

The conductive member 40 includes a flat conductive portion 41 and an insulating protective cover 50 that covers an outer peripheral surface of the conductive portion 41, and connects two electrical components. The two electrical components may each include a terminal to which the conductive member 40 is connected, and are two battery modules 11 in an example to be described later. Here, the conductive member 40 is disposed such that a longitudinal direction is the X-axis direction and a thickness direction is the Y-axis direction.

The conductive portion 41 is a bus bar formed of a conductive metal material. The conductive portion 41 is formed by, for example, pressing a sheet metal such as copper, iron, or aluminum. Alternatively, the conductive portion 41 may be formed by pressing a sheet metal of an alloy such as a copper alloy or an aluminum alloy.

The conductive portion 41 includes a body 42 covered with the protective cover 50, and a first connection portion 43a and a second connection portion 43b exposed from the protective cover 50 and electrically connected to the terminal of each electrical component. Since the body 42 is covered with the protective cover 50 and cannot be seen, the body 42 is indicated by a broken line in the drawing.

The first connection portion 43a is provided at an end 42a on a +X side of the body 42. The first connection portion 43a is bent to a +Y side with respect to the body 42. Specifically, the first connection portion 43a is bent at a substantially right angle from an edge portion 42e1 on a -Z side of the body 42 to the +Y side. Here, a bent portion between the first connection portion 43a and the body 42 is also referred to as a bent portion 44a. The bent portion 44a is provided on the -Z side with respect to the body 42.

The second connection portion 43b is provided at an end 42b on a -X side of the body 42. The second connection portion 43b is bent to the +Y side with respect to the body 42. More specifically, the second connection portion 43b is bent at a substantially right angle from an edge portion 42e2 on a +Z side of the body 42 to the +Y side. Here, a bent portion between the second connection portion 43b and the body 42 is also referred to as a bent portion 44b. The bent portion 44b is provided on the +Z side with respect to the body 42.

Each of the first connection portion 43a and the second connection portion 43b has a surface facing the Z-axis direction, and is provided with a through hole 45 penetrating in the Z-axis direction. The first connection portion 43a and the second connection portion 43b are connected to the electrical component, for example, by inserting a stud bolt provided at the terminal of the electrical component into the through hole 45 and fastening with a nut.

In this way, since the first connection portion 43a and the second connection portion 43b of the conductive portion 41 are bent with respect to the body 42, when the conductive member 40 is connected to the electrical component, the conductive member 40 does not protrude with respect to the electrical component, and a space around the electrical component is easily secured. Therefore, mountability of the electrical component can be improved.

The protective cover 50 is formed of an electrically insulating material such as a synthetic resin. The protective cover 50 has a shape along the body 42 of the conductive portion 41 and covers the body 42.

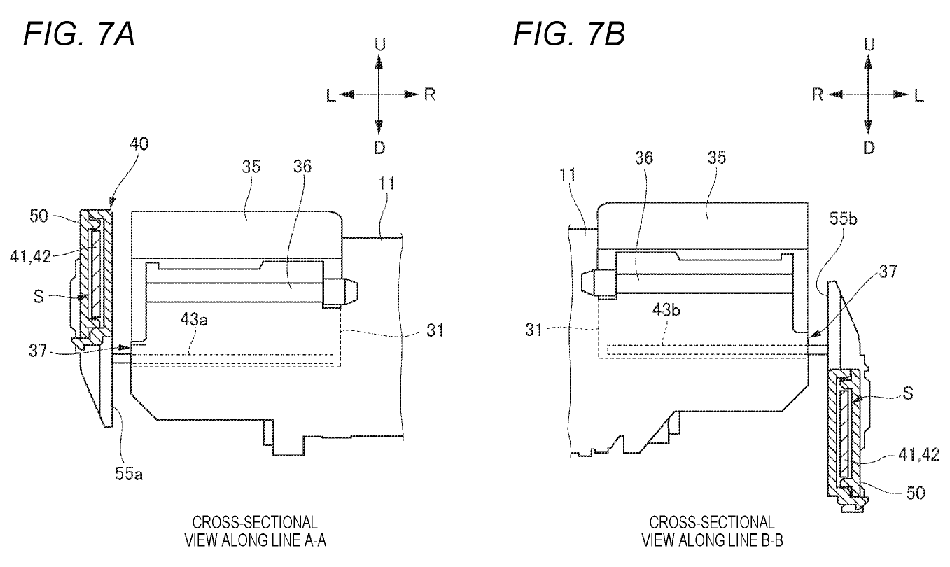

The protective cover 50 includes a first cover portion 51 that covers the body 42 of the conductive portion 41 from a -Y side, and a second cover portion 52 that covers the body 42 from the +Y side. In the first cover portion 51 and the second cover portion 52, recesses are formed on surfaces facing the body 42, and the body 42 is disposed in a space S defined by the recesses (see FIGS. 7A and 7B). The first cover portion 51 and the second cover portion 52 are provided with a plurality of holding portions 53 at peripheral edge portions thereof, and the first cover portion 51 and the second cover portion 52 are fixed to each other at the holding portions 53. Each holding portion 53 includes, for example, a claw portion and a hole portion that engages with the claw portion. In this way, the first cover portion 51 and the second cover portion 52 cover the body 42 to sandwich the body 42 from the thickness direction (Y-axis direction).

The protective cover 50 is provided with a first extension portion 55a and a second extension portion 55b extending from positions corresponding to the bent portions 44a and 44b of the conductive portion 41. The first extension portion 55a extends from the position corresponding to the bent portion 44a to the -Z side in the Z-axis direction. The second extension portion 55b extends from the position corresponding to the bent portion 44b to the +Z side in the Z-axis direction.

The first extension portion 55a and the second extension portion 55b have a plate shape covering the first connection portion 43a and the second connection portion 43b, respectively, when viewed in a direction from the -Y side to the +Y side.

Since the protective cover 50 is provided with the first extension portion 55a and the second extension portion 55b, for example, in a state where the two electrical components and the conductive member 40 are connected, it is possible to prevent a finger or a tool of an operator from coming into contact with the first connection portion 43a and the second connection portion 43b, and thus safety is ensured. In addition, as described above, since the conductive member 40 includes the first connection portion 43a and the second connection portion 43b bent with respect to the body 42, the mountability of the electrical component to which the conductive member 40 is connected is improved, and as a result, mountability and safety can both be achieved.

The conductive member 40 has an inclined portion 47 between the first connection portion 43a and the second connection portion 43b. The inclined portion 47 is provided at a central portion of the conductive member 40 in the X-axis direction, and is inclined toward the -Z side while extending toward the -X side.

The conductive member 40 has a point-symmetric shape with respect to a central axis C1 passing through a center of the conductive portion 41. The central axis C1 is an axis extending in the thickness direction (Y-axis direction) of the conductive member 40. Specifically, in FIG. 2, when the conductive member 40 is rotated 180° about the central axis C1, the conductive member 40 after the rotation and the conductive member 40 before the rotation coincide with each other. Therefore, when the conductive member 40 is connected to two electrical components, it is possible to prevent incorrect assembly and improve assemblability of the conductive member 40.

The body 42 of the conductive portion 41 is provided with a recess 48 formed by bending a plurality of portions. In the illustrated example, the recess 48 is recessed toward the +Y side by bending four portions of the body 42. Since the recess 48 is provided, even when the two electrical components connected by the conductive member 40 are relatively displaced, tolerance thereof is absorbed by elastic deformation of the conductive member 40 in the recess 48, and thus stress generated at the conductive portion 41 can be reduced.

At least in the recess 48, a gap is provided between the main body 42 and the protective cover 50. Specifically, the body 42 is not tightly fitted into the space S in the protective cover 50, and a gap is provided between the body 42 and the protective cover 50 to allow deformation of the conductive portion 41 in the space S to a certain extent. Accordingly, it is possible to prevent the protective cover 50 from being damaged due to deformation of the conductive portion 41.

Next, a conductive member attachment structure according to the embodiment of the present invention will be described. Specifically, an attachment structure in which the above-described conductive member 40 is attached to two electrical components will be described. Here, a case where two battery modules 11 are connected to the conductive member 40 will be described as an example. First, a battery pack 10 including the two battery modules 11 will be described.

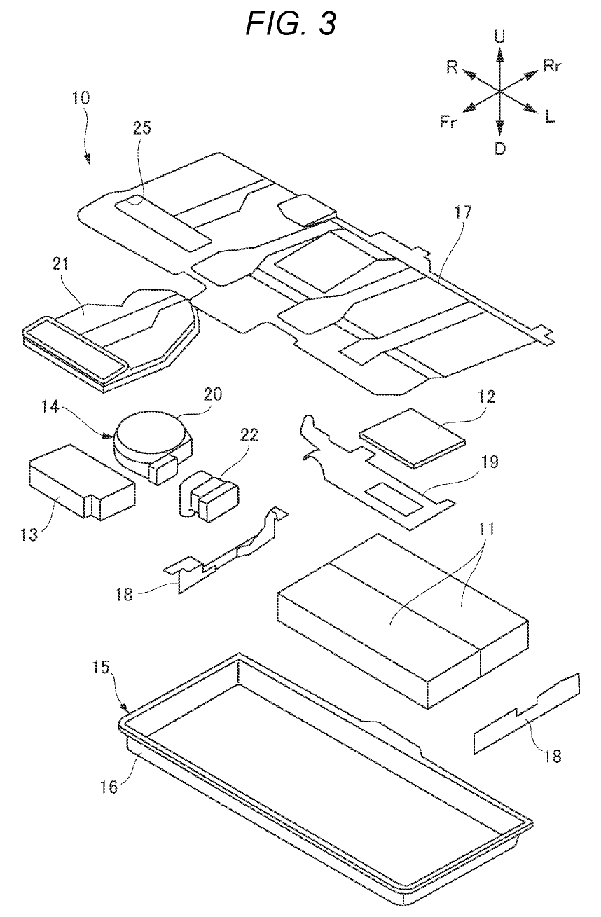

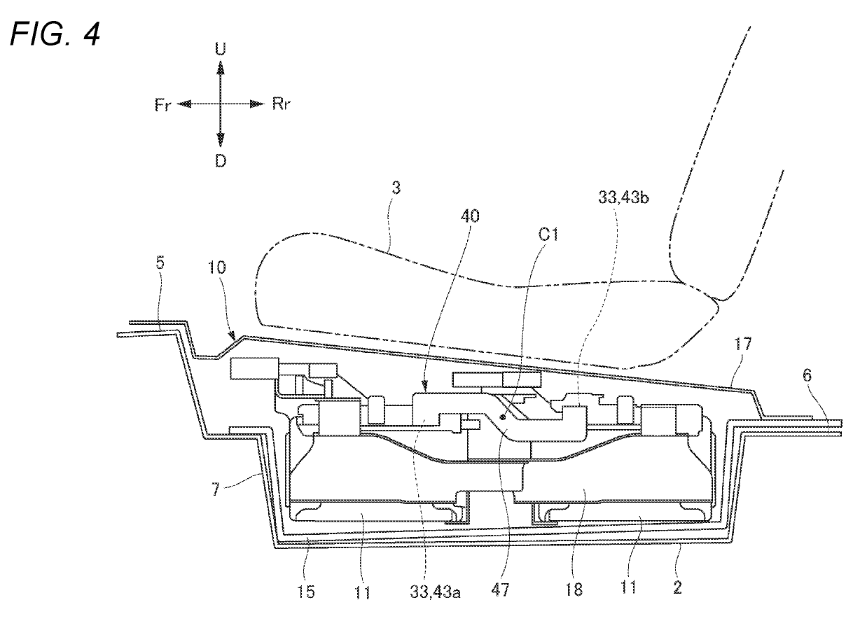

FIG. 3 is an exploded perspective view of the battery pack 10 mounted on a vehicle and including the battery modules 11. FIG. 4 is a side view of the battery pack 10 in the state where the two battery modules 11 are connected by the conductive member 40. Front, rear, left, right, upper, and lower sides of the vehicle where the battery pack 10 is mounted are denoted by Fr, Rr, L, R, U, and D, respectively.

The battery pack 10 is mounted on an electric vehicle such as a hybrid vehicle or a battery electric automobile. The battery pack 10 stores electric power to be supplied to a motor or the like serving as a drive source of the vehicle.

The battery pack 10 is mounted on a floor panel 2 of the vehicle. Specifically, the battery pack 10 is mounted to a recess 7 formed in the floor panel 2 and recessed downward with, for example, a cushioning material interposed therebetween. A seat 3 (front seat or rear seat) is provided above the battery pack 10, that is, the battery pack 10 is provided at a position below the seat 3. The seat 3 is disposed on a seat rail (not illustrated) suspended between a pair of front and rear cross members 5 and 6 of a vehicle body disposed in the front and rear of the battery pack 10.

The battery pack 10 includes two battery modules 11 disposed side by side in a front-rear direction, an electronic control unit (ECU) 12 that controls charging and discharging of the battery modules 11, a junction board 13 where wiring components through which a charging current and a discharging current of the battery modules 11 flow are mounted, a cooling mechanism 14 that cools the battery modules 11 with cooling air taken in from a passenger compartment, and a battery case 15 that accommodates these components.

The battery case 15 has a case body 16 that is a bottomed container opened at the top, and a case cover 17 which covers the case body 16 from above. The case body 16 accommodates the battery module 11, the ECU 12, the junction board 13, and the cooling mechanism 14. By fixing a front end and a rear end to the pair of front and rear cross members 5 and 6, the case cover 17 covers, from above, the case body 16 mounted on the floor panel 2. The case cover 17 is inclined rearward and downward.

The two battery modules 11 are disposed on a left side of the case body 16. Each battery module 11 is formed by stacking a plurality of battery cells, and has a rectangular parallelepiped shape whose left-right direction is a longitudinal direction. Each battery cell is, for example, a secondary battery such as a lithium ion battery or a nickel-metal hydride battery.

The two battery modules 11 are fixed to the case body 16 by module brackets 18 provided on left and right sides. The two battery modules 11 include terminals 33 at left ends thereof, and are electrically connected to each other by connecting the conductive member 40 to the respective terminals 33.

The ECU 12 is disposed above the battery modules 11 via an ECU bracket 19. The junction board 13 is disposed on a right side and a front side of the case body 16.

The cooling mechanism 14 includes a fan 20 that intakes air in the passenger compartment and blows the air to each battery module 11, an intake duct 21 connected to an intake port of the fan 20, and a blower duct 22 connected to a blower port of the fan 20. The cooling mechanism 14 is an air-cooled cooling device that cools the battery module 11 with air.

The intake duct 21 connects an intake grille 25 provided at a right end of the case cover 17 and the intake port of the fan 20. The blower duct 22 guides the air blown from the fan 20 to the battery module 11. The fan 20, the intake duct 21, and the blower duct 22 are disposed on a right side of the battery module 11 in the case body 16.

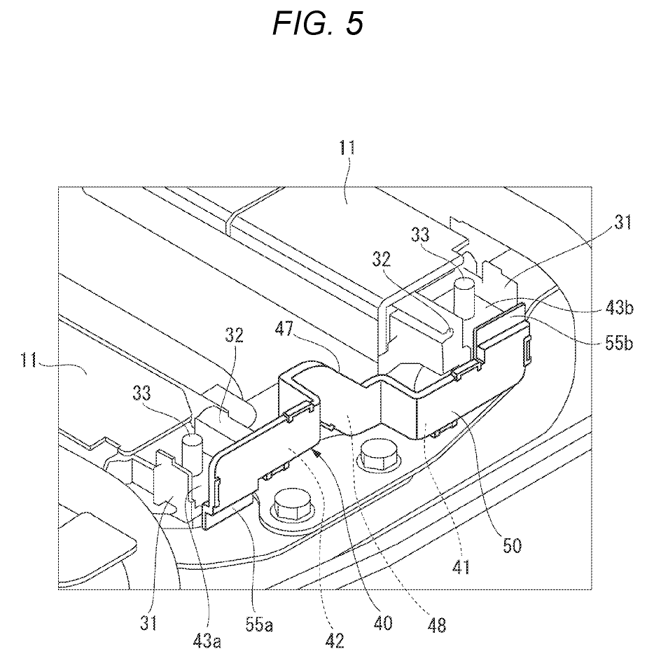

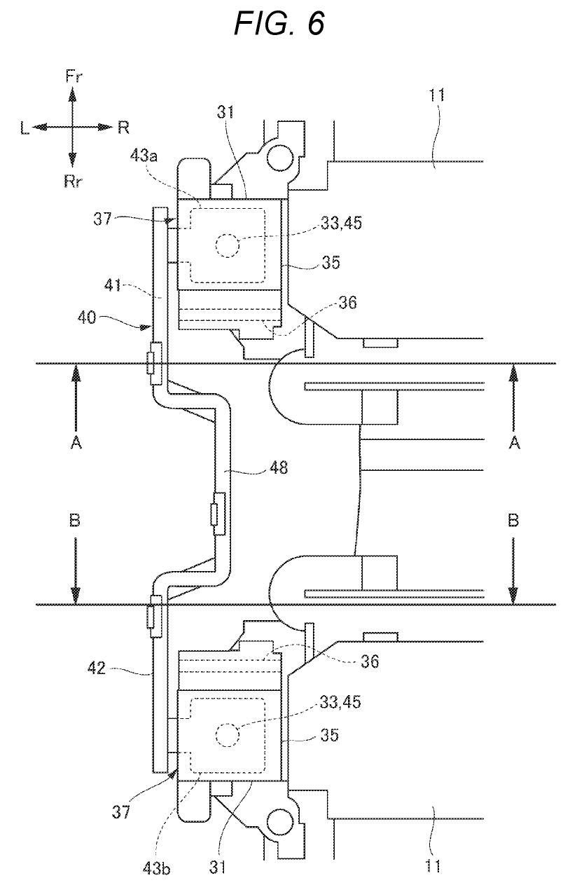

FIG. 5 is a perspective view of the conductive member 40 in a state where the two battery modules 11 are connected. FIG. 6 is a top view of the conductive member 40 in a state where the two battery modules 11 are connected. FIG. 7A is a cross-sectional view taken along line A-A in FIG. 6, and FIG. 7B is a cross-sectional view taken along line B-B.

Each battery module 11 includes a terminal block 31 including the terminal 33 to which the first connection portion 43a or the second connection portion 43b of the conductive member 40 is connected, and a terminal cover 35 disposed at the terminal block 31 and covering the terminal 33 to which the first connection portion 43a or the second connection portion 43b is connected. In FIG. 5, the terminal cover 35 is omitted.

The terminal 33 is provided with a stud bolt extending upward, and the stud bolt is inserted into the through hole 45 formed in the first connection portion 43a or the second connection portion 43b of the conductive member 40 and fastened with a nut (not illustrated). In the illustrated example, the first connection portion 43a of the conductive member 40 is connected to the terminal 33 (for example, a positive electrode) of the front battery module 11, and the second connection portion 43b of the conductive member 40 is connected to the terminal 33 (for example, a negative electrode) of the rear battery module 11.

The first connection portion 43a is bent with respect to the body 42 such that the body 42 is located above the first connection portion 43a. The second connection portion 43b is bent with respect to the body 42 such that the body 42 is located below the second connection portion 43b.

The terminal cover 35 is formed of an electrically insulating material such as a synthetic resin. The terminal cover 35 includes a pivot shaft 36 extending in the left-right direction. The pivot shaft 36 is provided at one end in the front-rear direction of the terminal cover 35. The terminal cover 35 is pivotably attached to the terminal block 31 by the pivot shaft 36 being pivotally supported by a bearing 32 (see FIG. 5) provided at an upper end of the terminal block 31. When the conductive member 40 is connected to the terminal 33, the terminal cover 35 opens an upper side of the terminal block 31, connects the conductive member 40 to the terminal 33, and then pivots to cover the upper side of the terminal block 31.

A slit 37 that allows the first connection portion 43a and the second connection portion 43b of the conductive member 40 to be inserted therethrough is provided between the terminal block 31 and the terminal cover 35. The body 42 of the conductive member 40 is disposed outside the terminal block 31, and the first connection portion 43a and the second connection portion 43b are connected to the terminal 33 of the terminal block 31 through the slit 37.

Since the first connection portion 43a is bent with respect to the body 42 such that the body 42 is located above the first connection portion 43a, an upper portion of the slit 37 of the front battery module 11 is covered by a portion of the protective cover 50 covering the body 42. In addition, since the second connection portion 43b is bent with respect to the body 42 such that the body 42 is located below the second connection portion 43b, a lower portion of the slit 37 of the rear battery module 11 is covered by the portion of the protective cover 50 covering the body 42. Therefore, it is possible to prevent a finger or a tool of the operator from coming into contact with the first connection portion 43a and the second connection portion 43b.

A lower portion of the slit 37 of the front battery module 11 and an upper portion of the slit 37 of the rear battery module 11 are covered by the first extension portion 55a and the second extension portion 55b of the protective cover 50.

The first extension portion 55a and the second extension portion 55b of the protective cover 50 have a plate shape covering the first connection portion 43a and the second connection portion 43b, respectively, and cover the slit 37 when viewed in a direction from the left side to the right side when the conductive member 40 is attached to the terminal 33 of the battery module 11.

More specifically, the first extension portion 55a extends downward from the position corresponding to the bent portion 44a between the first connection portion 43a and the body 42, and covers the lower portion of the slit 37 of the front battery module 11. The second extension portion 55b extends upward from the position corresponding to the bent portion 44b between the second connection portion 43b and the body 42, and covers the upper portion of the slit 37 of the rear battery module 11.

In this way, since the first extension portion 55a and the second extension portion 55b of the protective cover 50 cover the slit 37, it is possible to prevent a finger or a tool of the operator from coming into contact with the first connection portion 43a and the second connection portion 43b, and thus safety is ensured.

Since the conductive member 40 includes the first connection portion 43a and the second connection portion 43b bent with respect to the body 42, a left side of the battery module 11 to which the conductive member 40 is connected does not protrude, and a space beside the battery module 11 can be secured. Therefore, mountability of the battery module 11 with respect to the case body 16 is improved, and as a result, mountability and safety can both be achieved.

The conductive member 40 has the point-symmetric shape with respect to the central axis C1 passing through the center of the conductive portion 41. Therefore, unlike the illustration, the second connection portion 43b of the conductive member 40 can be connected to the front battery module 11 and the first connection portion 43a of the conductive member 40 can be connected to the rear battery module 11. In this way, incorrect assembly of the conductive member 40 can be prevented, and the assemblability of the conductive member 40 can be improved.

The conductive member 40 also has the inclined portion 47 between the first connection portion 43a and the second connection portion 43b. Therefore, a space above the conductive member 40 can be widened at the inclined portion 47. In the battery pack 10 of the present embodiment, as illustrated in FIG. 4, the case cover 17 is inclined rearward and downward, and since the conductive member 40 has the inclined portion 47, interference between the case cover 17 and the conductive member 40 can be prevented.

The recess 48 provided in the body 42 of the conductive portion 41 is recessed toward a space between the battery modules 11 disposed side by side in the front-rear direction. Accordingly, the space between the two battery modules 11 can be effectively used.

### Modification

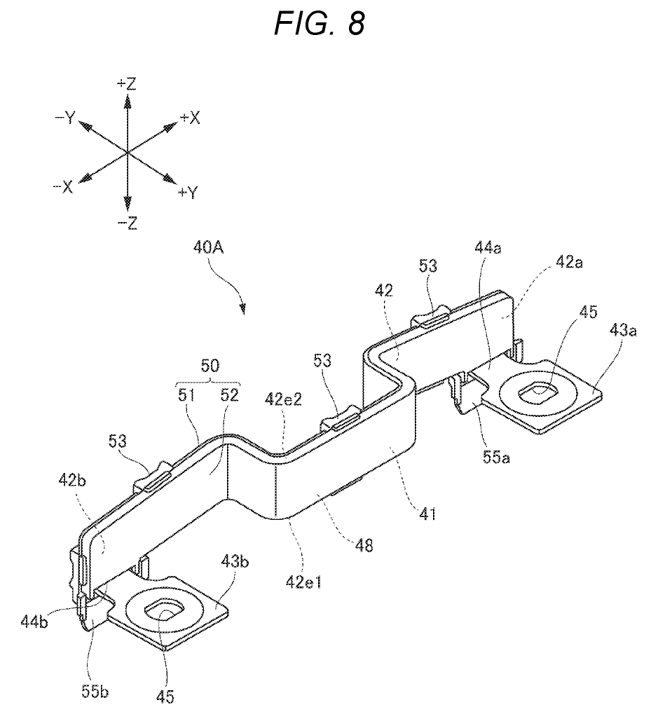

FIG. 8 is a perspective view of a conductive member 40A according to a modification. In the following description, the same components as those of the conductive member 40 in the above-described embodiment are denoted by the same reference signs, and descriptions thereof may be incorporated.

The conductive member 40A includes the flat conductive portion 41 and the insulating protective cover 50 that covers the outer peripheral surface of the conductive portion 41, and connects two electrical components.

The conductive portion 41 of the conductive member 40A has the same basic configuration as the conductive portion 41 of the conductive member 40, but configurations of the first connection portion 43a and the second connection portion 43b are different. Specifically, both the first connection portion 43a and the second connection portion 43b of the conductive member 40A are bent at a substantially right angle from the edge portion 42e1 on the -Z side of the body 42 to the +Y side.

The protective cover 50 of the conductive member 40A has the same basic configuration as the protective cover 50 of the conductive member 40, but configurations of the first extension portion 55a and the second extension portion 55b are different. Specifically, the first extension portion 55a and the second extension portion 55b of the conductive member 40A both extend from positions corresponding to the bent portions 44a and 44b to the -Z side in the Z-axis direction.

With such a configuration, in a state where the two electrical components and the conductive member 40A are connected, it is possible to prevent a finger or a tool of the operator from coming into contact with the first connection portion 43a and the second connection portion 43b, and thus safety is ensured. In addition, as described above, since the conductive member 40A includes the first connection portion 43a and the second connection portion 43b bent with respect to the body 42, mountability of an electrical component to which the conductive member 40A is connected is improved, and as a result, mountability and safety can both be achieved.

Although an embodiment and a modification of the present invention have been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, the constituent elements in the above embodiment may be freely combined without departing from the gist of the invention.

For example, in the embodiment and the modification described above, the conductive members 40 and 40A connect the terminals 33 of the two battery modules 11 in the battery pack 10, but the invention is not limited thereto, and may electrical components other than the battery modules 11 may be connected. For example, the conductive members 40 and 40A may connect the battery module 11 and the junction board 13. The conductive members 40 and 40A are not limited to connecting electrical components in the battery pack 10 of the vehicle, and may connect any two electrical components. The any two electrical components are not limited to those mounted on the vehicle.

In the embodiment and the modification described above, the first connection portion 43a and the second connection portion 43b are both bent with respect to the body 42, and alternatively, only one connection portion may be bent with respect to the body 42. In this case, the extension portion of the protective cover 50 may be provided at a position corresponding to a bent portion between the one connection portion and the body 42.

In the present specification, at least the following matters are described. In parentheses, the corresponding constituent elements and the like in the above embodiment are shown as an example, but the present invention is not limited thereto.

(1) A conductive member (conductive member 40, 40A) including:

a flat conductive portion (conductive portion 41); and

an insulating protective cover (protective cover 50) provided to cover an outer peripheral surface of the conductive portion, in which

the conductive member is configured to connect two electrical components (battery modules 11),

the conductive portion includes

a body (body 42) covered with the protective cover, and

a first connection portion (first connection portion 43a) and a second connection portion (second connection portion 43b) exposed from the protective cover and being to electrically connected to a terminal (terminal 33) of each electrical component,

at least one connection portion among the first connection portion and the second connection portion is bent with respect to the body, and

the protective cover is provided with an extension portion (first extension portion 55a, second extension portion 55b) extending from a position corresponding to a bent portion (bent portion 44a, 44b) between the at least one connection portion and the body.

According to (1), since the connection portion of the conductive portion is bent with respect to the body, mountability of the electrical component to which the conductive member is connected is improved. In addition, in the conductive member including such a bent connection portion, since the protective cover is provided with the extension portion extending from the position corresponding to the bent portion between the connection portion and the body, it is possible to prevent a hand or a tool of an operator from coming into contact with the connection portion in a state where the electrical component and the conductive member are connected. Therefore, it is possible to achieve both mountability and safety.

(2) The conductive member according to (1), in which

the extension portion has a plate shape covering the at least one connection portion when viewed from a first direction.

According to (2), it is possible to reliably prevent a hand or a tool of the operator from coming into contact with the connection portion.

(3) The conductive member according to (1) or (2), in which

the first connection portion and the second connection portion are bent with respect to the body, and

the conductive member has a point-symmetric shape with respect to a central axis (central axis C1) passing through a center of the conductive portion.

According to (3), when the conductive member is connected to two electrical components, it is possible to prevent incorrect assembly and improve assemblability of the conductive member.

(4) The conductive member according to any one of (1) to (3), in which

the body of the conductive portion is provided with a recess (recess 48) formed by bending a plurality of portions.

According to (4), even when the two electrical components connected by the conductive member are relatively displaced, tolerance thereof is absorbed by the recess provided in the conductive portion, and thus stress generated in the conductive portion can be reduced.

(5) The conductive member according to (4), in which

a gap is provided between the protective cover and the body of the conductive portion in at least the recess.

According to (5), it is possible to prevent the protective cover from being damaged due to deformation of the conductive portion.

(6) A conductive member attachment structure including:

the conductive member (conductive member 40, 40A) according to (1); and

a first electrical component (front battery module 11) and a second electrical component (rear battery module 11) respectively connected to the first connection portion and the second connection portion of the conductive member, in which

the first electrical component and the second electrical component each include

a terminal block (terminal block 31) including a terminal (terminal 33) to which the first connection portion or the second connection portion of the conductive member is connected, and

a terminal cover (terminal cover 35) disposed at the terminal block and covering the terminal to which the first connection portion or the second connection portion is connected,

a slit (slit 37) that allows the first connection portion or the second connection portion to be inserted therethrough is provided between the terminal block and the terminal cover, and

the extension portion of the protective cover has a plate shape covering the slit when viewed from a first direction.

According to (6), the extension portion of the protective cover can prevent a hand or a tool of the operator from coming into contact with the connection portion through the slit.

(7) The conductive member attachment structure according to (6), in which

the first connection portion is bent with respect to the body such that the body is located on one side in a second direction orthogonal to the first direction with respect to the first connection portion,

the second connection portion is bent with respect to the body such that the body is located on another side in the second direction with respect to the second connection portion, and

the extension portion of the protective cover includes

a first extension portion (first extension portion 55a) extending from a position corresponding to the bent portion between the first connection portion and the body to the another side in the second direction, and

a second extension portion (second extension portion 55b) extending from a position corresponding to the bent portion between the second connection portion and the body to the one side in the second direction.

According to (7), it is possible to prevent a finger or a tool of the operator from coming into contact with the connection portion in a state where the electrical component and the conductive member are connected.

(8) The conductive member attachment structure according to (7), in which

the conductive member has a point-symmetric shape with respect to a central axis passing through a center of the conductive portion.

According to (8), when the conductive member is connected to the first electrical component and the second electrical component, it is possible to prevent incorrect assembly and improve assemblability of the conductive member.

(9) The conductive member attachment structure according to (7) or (8), in which

the conductive member has an inclined portion (inclined portion 47) between the first connection portion and the second connection portion.

According to (9), a space on one side in the second direction with respect to the conductive member can be widened.

(10) The conductive member attachment structure according to any one of (6) to (9), in which

the body of the conductive portion is provided with a recess (recess 48) formed by bending a plurality of portions, and

the recess is formed to be recessed toward a space between the first electrical component and the second electrical component.

According to (10), even when the two electrical components connected by the conductive member are relatively displaced, tolerance thereof is absorbed by the recess provided in the conductive portion, and thus stress generated in the conductive portion can be reduced. Since the recess is recessed toward the space between the first electrical component and the second electrical component, the space between the first electrical component and the second electrical component can be effectively used.

### REFERENCE SIGNS LIST

11 battery module (electrical component, first electrical component, second electrical component)

31 terminal block

33 terminal

35 terminal cover

37 slit

40, 40A conductive member

41 conductive portion

42 body

43a first connection portion (connection portion)

43b second connection portion (connection portion)

44a, 44b bent portion

47 inclined portion

48 recess

50 protective cover

55a first extension portion (extension portion)

55b second extension portion (extension portion)

C1 central axis

What is claimed is:

1. A conductive member comprising:
a flat conductive portion; and
an insulating protective cover provided to cover an outer peripheral surface of the conductive portion, wherein
the conductive member is configured to connect two electrical components,
the conductive portion includes
a body covered with the protective cover, and
a first connection portion and a second connection portion that are exposed from the protective cover and are to be electrically connected to a terminal of each of the electrical components,
at least one connection portion among the first connection portion and the second connection portion is bent with respect to the body, and
the protective cover is provided with an extension portion extending from a position of the protective cover corresponding to a bent portion between the at least one connection portion and the body.

2. The conductive member according to claim 1, wherein
the extension portion has a plate shape covering the at least one connection portion when viewed from a first direction.

3. The conductive member according to claim 1, wherein
the first connection portion and the second connection portion are bent with respect to the body, and
the conductive member has a point-symmetric shape with respect to a central axis passing through a center of the conductive portion.

4. The conductive member according to claim 1, wherein
the body of the conductive portion is provided with a recess formed by bending a plurality of portions of the body.

5. The conductive member according to claim 2, wherein
the body of the conductive portion is provided with a recess formed by bending a plurality of portions of the body.

6. The conductive member according to claim 3, wherein
the body of the conductive portion is provided with a recess formed by bending a plurality of portions of the body.

7. The conductive member according to claim 4, wherein
a gap is provided between the protective cover and the body of the conductive portion in at least the recess.

8. The conductive member according to claim 5, wherein
a gap is provided between the protective cover and the body of the conductive portion in at least the recess.

9. The conductive member according to claim 6, wherein
a gap is provided between the protective cover and the body of the conductive portion in at least the recess.

10. A conductive member attachment structure comprising:
the conductive member according to claim 1; and
a first electrical component and a second electrical component respectively connected to the first connection portion and the second connection portion of the conductive member, wherein
the first electrical component and the second electrical component each include
a terminal block including a terminal to which the first connection portion or the second connection portion of the conductive member is connected, and
a terminal cover disposed at the terminal block and covering the terminal to which the first connection portion or the second connection portion is connected,
a slit that allows the first connection portion or the second connection portion to be inserted therethrough is provided between the terminal block and the terminal cover, and
the extension portion of the protective cover has a plate shape covering the slit when viewed from a first direction.

11. The conductive member attachment structure according to claim 10, wherein
the first connection portion is bent with respect to the body such that the body is located on one side in a second direction orthogonal to the first direction with respect to the first connection portion,
the second connection portion is bent with respect to the body such that the body is located on another side in the second direction with respect to the second connection portion, and
the extension portion of the protective cover includes
a first extension portion extending from a position corresponding to the bent portion between the first connection portion and the body to the another side in the second direction, and
a second extension portion extending from a position corresponding to the bent portion between the second connection portion and the body to the one side in the second direction.

12. The conductive member attachment structure according to claim 11, wherein
the conductive member has a point-symmetric shape with respect to a central axis passing through a center of the conductive portion.

13. The conductive member attachment structure according to claim 11, wherein
the conductive member has an inclined portion between the first connection portion and the second connection portion.

14. The conductive member attachment structure according to claim 12, wherein
the conductive member has an inclined portion between the first connection portion and the second connection portion.

15. The conductive member attachment structure according to claim 11, wherein
the body of the conductive portion is provided with a recess formed by bending a plurality of portions of the body, and
the recess is formed to be recessed toward a space between the first electrical component and the second electrical component.

16. The conductive member attachment structure according to claim 12, wherein
the body of the conductive portion is provided with a recess formed by bending a plurality of portions of the body, and
the recess is formed to be recessed toward a space between the first electrical component and the second electrical component.
